(19) United States
(12) Patent Application Publication
(10) Pub. No.: US 2007/0290987 A1
(43) Pub. Date: Dec. 20, 2007

(54) Multifunctional mouse

(76) Inventor: Shao-Jay Din, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/705,610

(22) Filed: Feb. 13, 2007

(30) Foreign Application Priority Data
Feb. 15, 2006 (JP) JP2006-000985

(51) Int. Cl. G09G 5/00

(52) U.S. Cl. 345/156

(57) ABSTRACT

A multifunctional mouse includes a poke stick at a side of its housing. The poke stick is extended to a control circuit inside the housing, and a turning wheel is located at a front middle position of the housing. By using a thumb to touch the poke stick to move forward and backward, and other fingers to touch the turning wheel to move left and right, a mouse pointer is moved, enabling a user to manipulate the mouse pointer in a way in compliance with ergonomics, thereby reducing an injury to hands. More particularly, a bottom surface of the housing is provided with a game buttons assembly which is linked with a control circuit, enabling the entire mouse not only to be provided with functions of controlling the mouse pointer and performing point-and-click tasks, but also even to serve as a controller for game software.

### BACKGROUND OF THE INVENTION

(a) Field of the Invention

The present invention relates to a multifunctional mouse, and more particularly to a multifunctional mouse that allows a user to manipulate a mouse pointer in a way which is in compliance with ergonomics, and that can be used as a controller for game software.

(b) Description of the Prior Art

In terms of usage habit of existing personal computer users, a mouse is one of indispensable input equipment. It is called the mouse, because it can be agile like a real mouse and can replace our fingers to do a lot of point-and-click tasks. Furthermore, since the development of first generation of mechanical mouse, the displacement transduction module of the mouse has been gone through many development stages, including the opto-mechanical module and the opto-electrical module; even now the wireless transmission module can be used by the mouse to transmit signals to a computer.

In addition, as the development of mouse is continuously toward an extremely precise positioning and a personalization of shape, the mouse which only serves as an accessory originally has gradually become a main stream of desktop equipment, which also means that time spent in operating the mouse by the user will be increased. Most of the mice on the existing market are equipped with functions of manipulating the mouse pointer and doing the point-and-click tasks. However, most of them only focus on the design of appearance and shape. Moreover, for the conventional way of moving the mouse pointer, the entire mouse must be moved toward corresponding direction of the movement of mouse pointer, to achieve a purpose of manipulating the mouse pointer, under detection of the displacement transduction module. Nevertheless, this manipulation method will result in an error of various degrees according to dirtiness on a mouse pad, and as the time in operating the mouse increases, fatigue will be resulted to a wrist, an arm, and a shoulder or even an accumulative injury will occur.

Referring to FIG. 1, it shows a conventional mouse structure wherein a front middle position of a housing 10 is provided with a turning wheel 20 to control left and right movements of a mouse pointer. However, as a rim of this conventional turning wheel 20 is designed as a protruded shape, not only that a sense of touch of fingers 60 with the turning wheel 20 will be affected, but also that the fingers 20 should be moved to two sides of the turning wheel 20 that the turning wheel 20 can be touched to move toward the corresponding direction, thereby resulting in undesirable practicability and convenience of use, and causing that the fingers are easily fatigued or even injured.

### SUMMARY OF THE INVENTION

Accordingly, the primary object of present invention is to provide a multifunctional mouse wherein a side of a housing of the mouse is provided with a poke stick which is extended to a control circuit in an interior of the housing, and a front middle position of the housing is provided with a turning wheel, such that by using a thumb to touch the poke stick to move forward and backward, and other fingers to touch the turning wheel to move toward left and right, a mouse pointer is moved, which allows a user to manipulate the mouse pointer in a way that is in compliance with ergonomics, to reduce an injury to hands.

Upon implementing, the mouse is still equipped with an opto-mechanical or opto-electrical displacement transduction module, to increase convenience of usage and applicability. Furthermore, a bottom surface of the housing is provided with a game buttons assembly which is linked with a control circuit. Accordingly, the entire mouse not only is provided with the functions of controlling the mouse pointer and performing the point-and-click tasks, but also can be used as a controller for game software.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a way of manipulating a turning wheel of a conventional mouse.

FIG. 2 shows a perspective view of a mouse of the present invention.

FIG. 3 shows an exploded elevational view of a mouse structure of the present invention.

FIG. 4 shows a schematic view of moving a poke stick of the present invention.

FIG. 5 shows another schematic view of moving a poke stick of the present invention.

FIG. 6 shows a schematic view of manipulating a turning wheel of the present invention.

FIG. 7 shows a schematic view of a structure at a bottom surface of another embodiment of a mouse of the present invention.

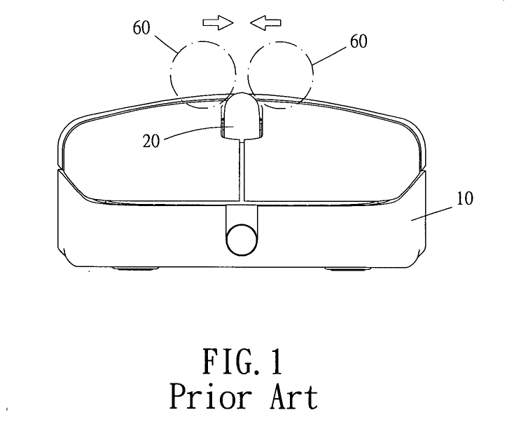

### DETAILED DESCRIPTION OF THE PREFERRED EMBODIMENTS

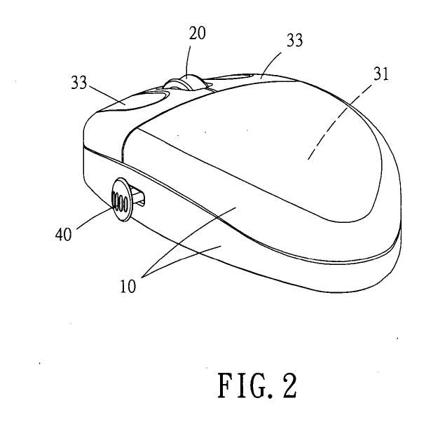

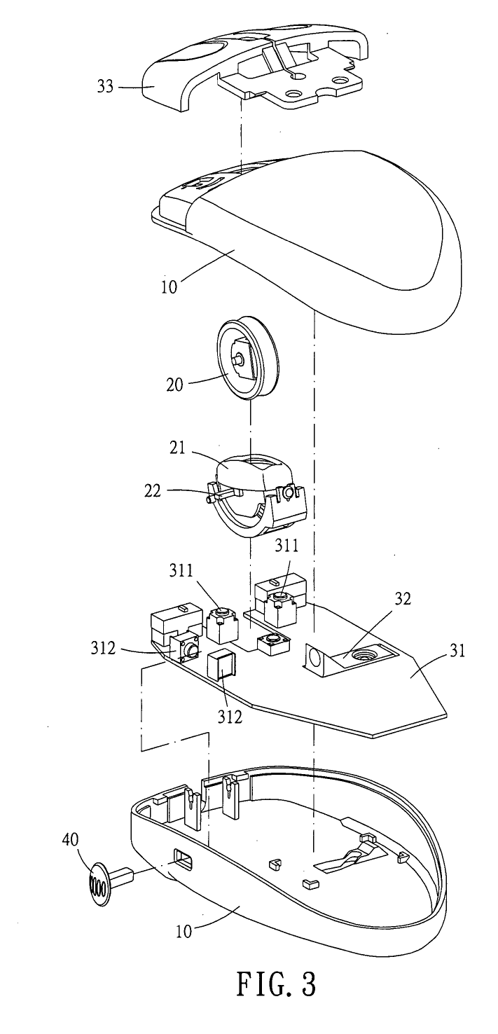

Referring to FIG. 2 and FIG. 3, a basic structure of an entire multifunctional mouse of the present invention includes a housing 10 which is convenient to hold by a user, and is used to assemble related mechanical structures. An interior of the housing 10 is provided with a control circuit 31 which is linked to a displacement transduction module 32 and operation buttons 33. In addition, a front middle position of the housing 10 is provided with a turning wheel 20 which is linked to the control circuit 31.

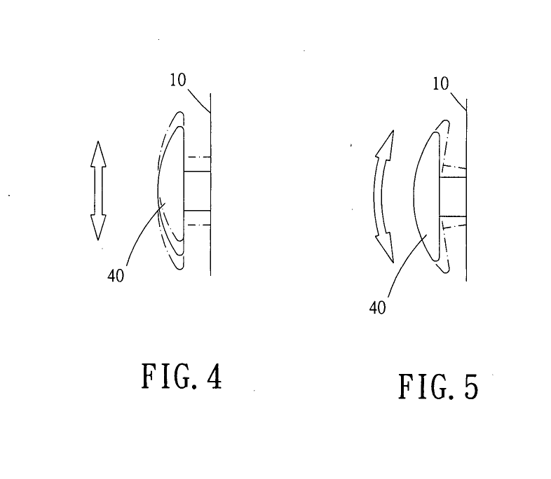

Upon implementing, the turning wheel 20 is crossed over a wheel seat 21, and two sides of the wheel seat 21 are provided with transversal rods 22 which are extended to tact switches 311 on the control circuit 31. Rotation of the turning wheel 20 will be inducted by the wheel seat 21, and left and right movements of the turning wheel 20 will be inducted by the tact switches 311. Moreover, a side of the housing 10 is provided with a poke stick 40 which passes through the housing 10 and is extended to a place between two touch switches 312 on the control circuit 31, as well as can move forward and backward by sliding (as shown in FIG. 4), or by swinging (as shown in FIG. 5). The forward and backward movements of the poke stick 40 will be inducted by these two touch switches 312.

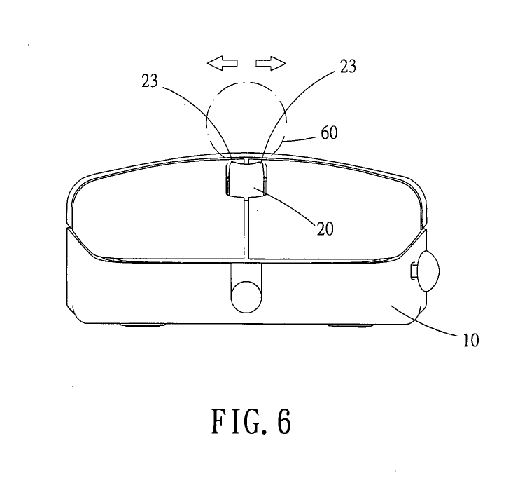

Accordingly, a mouse pointer can be moved by using a thumb to touch the poke stick 40 to move forward and backward, and by using other fingers to touch the turning wheel 20 to move toward left and right, enabling the user to manipulate the mouse pointer in a way that is in compliance with ergonomics, thereby reducing an injury to hands. It is worth to mention that a rim of the turning wheel 20 is designed as a concaved shape, which results in a more comfortable feeling when a finger 60 is in contact with the turning wheel 20; and, as shown in FIG. 6, when the finger 60 is put on the rim of the turning wheel 20, locations on this concaved-shape rim, corresponding to two sides of the finger 60, are formed with two projected parts 23 allowing the finger 60 to contact, which enables the turning wheel 20 to move toward left and right following the finger 60, thereby improving practicability and convenience of use of the turning wheel 20.

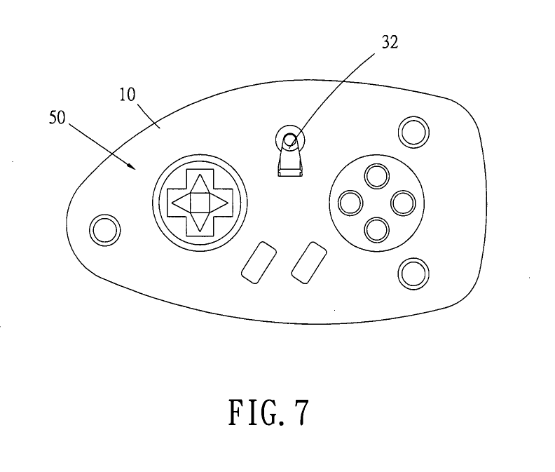

Furthermore, as the entire mouse is still equipped with the opto-mechanical or opto-electrical displacement transduction module 32, an operation habit of the user can be satisfied, and the convenience of use and applicability can be improved. In particular, referring to FIG. 7, a bottom surface of the housing 10 can be further provided with a game buttons assembly 50 which is linked with the control circuit 31, enabling the entire mouse to be not just provided with functions of manipulating the mouse pointer and performing point-and-click tasks, but even to serve as a controller for game software.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multifunctional mouse comprising a housing, which is used to assemble related mechanical structures; a control circuit, which is installed in an interior of the housing, and is linked with operation buttons; a turning wheel, which is installed at a front middle position of the housing and is used to control left and right movements of a mouse pointer; and a poke stick, which is installed at a middle position of a side of the housing, and is used to control the mouse pointer to move forward and backward.

2. The multifunctional mouse according to claim 1, wherein the turning wheel is crossed over a wheel seat, two sides of which are provided with transversal rods being extended to tact switches on the control circuit, with rotation of the turning wheel being inducted by the wheel seat, and left and right movements of the turning wheel being inducted by the tact switches.

3. The multifunctional mouse according to claim 1 or 2, wherein the poke stick passes through the housing and is extended to a location between two touch switches on the control circuit, with front and back movements of the poke stick being inducted by the two touch switches.

4. The multifunctional mouse according to claim 1, wherein a rim of the turning wheel is in a concaved shape.

5. The multifunctional mouse according to claim 1, wherein the control circuit is linked with an opto-mechanical displacement transduction module.

6. The multifunctional mouse according to claim 1, wherein the control circuit is linked with an opto-electrical displacement transduction module.

7. The multifunctional mouse according to claim 1, wherein a bottom surface of the housing is provided with a game buttons assembly which is linked with the control circuit.
